(19) United States
(12) Patent Application Publication
(10) Pub. No.: US 2024/0073318 A1
(43) Pub. Date: Feb. 29, 2024

(54) SYSTEM AND METHOD FOR TRANSMITTING AUDIO MESSAGES IN A TELEPHONIC CALL

(71) Applicant: Elio B. Casamassima, Bronx, NY (US)

(72) Inventor: Elio B. Casamassima, Bronx, NY (US)

(21) Appl. No.: 18/190,603

(22) Filed: Mar. 27, 2023

Related U.S. Application Data
(60) Provisional application No. 63/474,546, filed on Aug. 24, 2022.

(51) Int. Cl. H04M 3/42

(52) U.S. Cl. CPC H04M 3/42017

(57) ABSTRACT

A system and method for playing audio messages between signal tones in a telephonic call. The signal tones indicate the status or progress of the ongoing call and is played at timed intervals. The system can play audio messages between the signal tones that can be heard by the caller. The audio messages can be advertisements.

### CROSS-REFERENCE TO RELATED APPLICATIONS

This application claims priority from a U.S. provisional patent application Ser. No. 63/474,546, filed on Aug. 24, 2022, which is incorporated herein by reference in its entirety.

### FIELD OF INVENTION

The present invention relates to the field of telephony, and more particularly, the present invention relates to a system and method for transmitting audio messages to a telephonic caller.

### BACKGROUND

Ring back tones, also known as ringing tones or audible ringing, are known in the art as signals in telecommunication played by a telephonic operator to a caller waiting for a call to be answered. The signals are periodic in the form of tones that indicates the call is being connected or yet to be answered. There is a time gap between two consecutive signals, such as about 5 seconds but can vary. These signals in the form of tones are played by the carrier network. These signals last until the call is answered or terminated. Typically, there is a blank/silence between two consecutive signals.

The telephone units are generally connected to a switching system through networks such as a PSTN network or cellular network.

The signals typically indicate the progress or status of a call to a user making the call, such as a ringing tone or busy tone. In case of call is being forwarded, the operators can play a different tone.

There is always an industry need to generate new revenue opportunities. Also, a need is there to utilize spaces between the ringing tones.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for generating additional revenue by utilizing blank spaces between ringing tones.

It is another object of the present invention that the system and method provide for targeting advertisement.

It is still another object of the present invention that the system and method provide for generating additional revenue.

It is yet another object of the present invention that the system and method can make the monotonous ringing tone interesting.

It is a further object of the present invention that the system and method allow for bettering utilization of resources.

In one aspect, disclosed is a method for transmitting audio messages in a telephonic call, the method comprising detecting, signal tones generated by a generator, the signal tones played to a caller waiting for a call to be answered, wherein the signal tones indicate a status of the ongoing call, wherein consecutive signal tones are separated by a predefined duration; and playing, by a playing unit, one or more audio messages between the consecutive signal tones, so that the caller can hear the one or more audio messages. The predefined duration can be about 5 seconds. The method further comprises receiving a plurality of audio messages from an external server; and processing, by an audio processing unit, the plurality of audio messages to a predetermined format and duration. The generator and the playing unit are different. The method further comprises determining the predefined duration based on the detected signal tones. The method further comprises receiving information about playing of the plurality of audio messages from the external server, wherein the information comprises number of times an audio message of the plurality of messages is to be played, area codes for which the audio message is to be played, and days in which the audio message is to be played.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is an environmental view of the system, according to an exemplary embodiment of the present invention.

FIG. 2 is a block diagram showing the architecture of the system, according to an exemplary embodiment of the present invention.

FIG. 3 is a flow chart showing an implementation of the system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method for playing audible messages to a caller making a telephonic call through a telephonic network. The audio messages are played between the signal tones as heard by the caller. The audio messages can be advertisements, information, and the like.

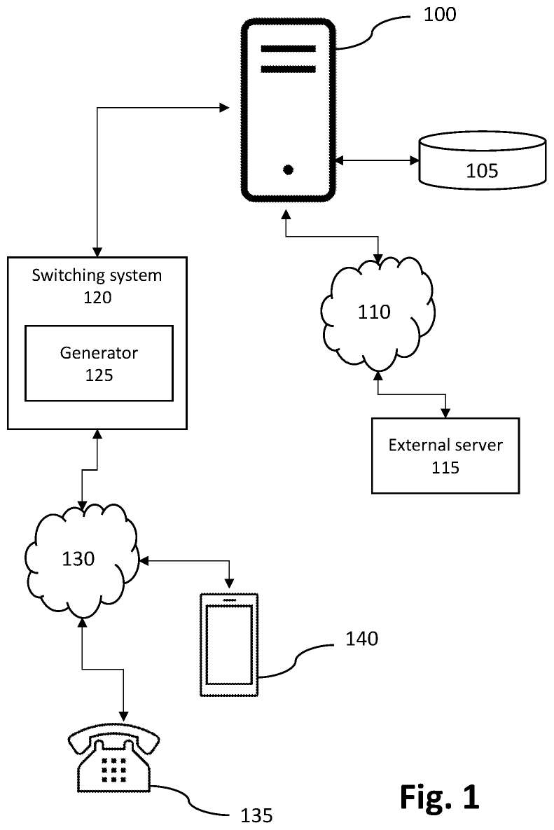

Referring to FIG. 1, which is a block diagram showing an environment of the disclosed system 100. The system 100 can be coupled to a switching system 120 of a carrier network 130 The switching systems are known in telecommunications. The switching system 120 can include a generator 125 for generating the signal tones. The generator can generate distinct kinds of signal tones for different statuses or the progress of an ongoing call. For example, a ringing tone for a call waiting to be answered by a receiver of the call, a busy tone indicating that the receiver of the call is on another call, a call forwarding tone, and the like. Such signal tones are well-known in the art. Between two consecutive tones, a blank space is there which is referred to herein as space, the space is of a predefined duration. The duration can vary between different telephonic operators and the types of signal tones.

The switching system 120 can connect to user devices through a carrier network 130. The user device can be a telephone unit 135, a mobile unit 140, a wireless telephonic unit, and the like. The carrier network can be a wired network, a wireless network, or a combination of a wired network and a wireless network. The user devices can connect through a PSTN or cellular network. It is understood that multiple user devices can connect with the switching system simultaneously or at various times.

The system can also connect to an external server for receiving audio messages and details of playing the audio messages. The system can connect to an external server 115 through a network 110, for receiving and uploading data to the external server. The network 110 can be a wired network, a wireless network, or a combination of a wired network and a wireless network. For example, the network 110 may be a local area network (LAN), a wide area network (WAN), a wireless WAN, a wireless LAN (WLAN), a metropolitan area network (MAN), a wireless MAN network, a cellular data network, a cellular voice network, the Internet

The system 100 can also connect to a database 105 for storing audio messages. The database can be a part of the system or separate from the system. The database when separate can be connected through the network.

Also, it is understood, the embodiments of the disclosed system can be implemented within the PSTN system. For example, a switching system may embody the disclosed system and methods thereof, and such as switching system is within the scope of the present invention.

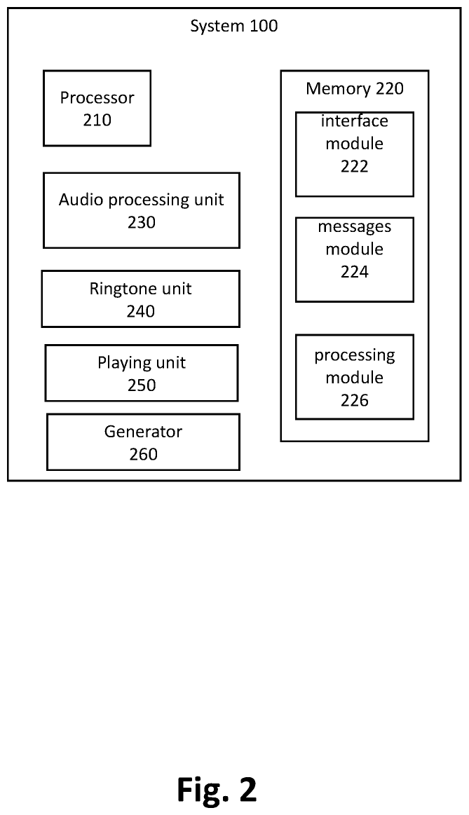

Referring to FIG. 2 is a block diagram showing the architecture of the disclosed system 100. The system includes a processor 210 and memory 220. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology.

The system may also include an audio processing unit 230, a ringtone unit 240, and a playing unit 250, and a generator 260. The memory can include an interface module 222, a messages module 224, and a processing module 226 which when executed by the processor may perform one or more steps of the disclosed methodology.

The audio processing unit can process the audio message received from the external server in predetermined formats. The audio processing units can also verify the duration of the audio message. Also, the audio processing unit can trim and split the audio messages based on preset instructions. The audio processing unit can be operably coupled to the processor and can receive instructions for processing the audio messages.

The playing unit can play the audio message to the user's device. The playing unit can be operably coupled to the processor and can receive the audio message. For example, the processor can access the audio message stored in the database and provide the same to the playing unit for playing the audio message.

The ringtone unit can be coupled to the generator of the switching system and the processor of the disclosed system. The ringtone unit can detect the type of signal tone generated by the disclosed system. Also, the disclosed system can determine the space between the signal tones based on the type of signal tones. Alternatively, the duration of space can be preset in the disclosed system.

The disclosed system may also include the generator 260 for generating the signal tones. In one implementation, the playing unit and the generator can be the same. Alternatively, the playing unit and the generator can be different. The disclosed system can play the signal tones and also play the audio messages between the signal tones.

The interface module upon execution by the processor can provide an interface for interacting with the disclosed system. Through the interface, information can be presented to the user and the information can be received from the user. The message module upon execution by the processor can provide for processing of the audio messages for storing and playing. The message module allows configuring sequence of the audio messages that has to be played, order in which the audio messages have to be played, and when the audio messages must be played. For example, different audio messages can be played at different times, days, occasions, and the like. For example, the hours and the days of the transmission of the audio messages may change from area code to area code and within the same area code in the course of the year and Holidays. The message module may take such configuration through the interface. It can be specified how many audio messages has to be played. The message module can download the audio messages from external servers.

The processing module may coordinate and operate different components of the disclosed system.

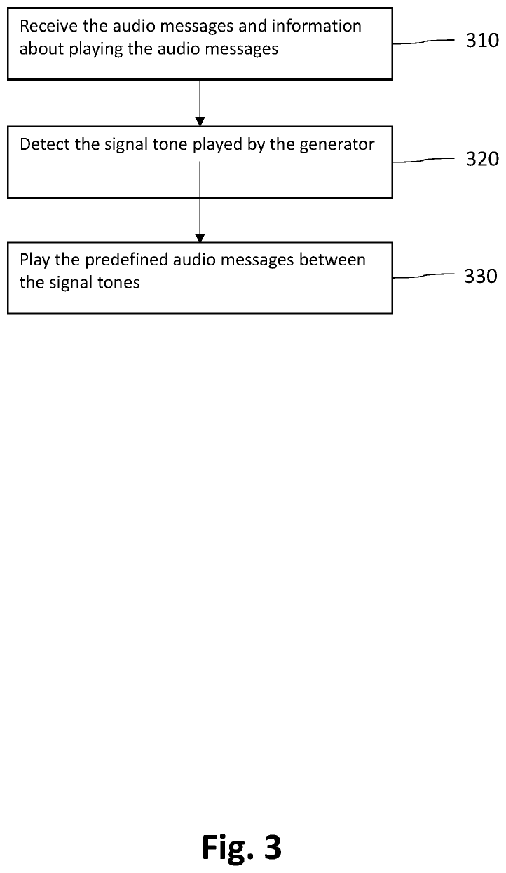

Referring to FIG. 3 which is a flow chart illustrating the disclosed methodology. The disclosed system can receive the audio messages and information about playing the audio messages, at step 310. Such audio messages can be advertisements that can generate revenue for at least the telephonic operator. Playing the advertisements can also be rewarding for the callers, based on the requirements and plans of the telephonic operator.

The audio messages can be of a duration less than the duration of the space between two consecutive signal tones. As such one or more audio messages can be played between two consecutive signals tones, wherein the overall length of the audio messages can be the same or less than the space duration.

The information about playing the audio messages can include how and when an audio message can be played. For example, the disclosed system can play a predetermined number/list of audio messages in a sequence and upon finishing the list, the sequences can be restarted. Thus, the audio messages can be placed in a loop for a predefined duration. The predefined duration can be hours, days, weeks, months, and the like. For example, when a user makes a call, it takes about 60 seconds for the receiver to pick up the call. In 60 seconds, the caller may hear about 10-12 signal tones, wherein the signal tones have about five seconds of space. Each audio message can be about 4.5 seconds long. The disclosed system based on the information can make a sequence audio messages for playing. In the above case, the system can play about 10 to 12 audio messages in between the respective signal tones. It is understood that one or more than one audio message can be repeatedly played in a call without departing from the scope of the present invention. The disclosed system can be configured to play the audio messages in any desired sequence, and such sequence or random playing of the audio messages is within the scope of the present invention.

The system can then detect the signal tone played by the generator, at step 320. Upon detecting the signal tone including the type of signal tone, the system can play the predefined audio messages. The disclosed system can play general audio messages, such as advertisements to the public at large. Alternatively, the disclosed system can also provide targeted advertisements. For example, the disclosed system can also determine certain information about the caller, such as the phone number or area location of the caller for targeted advertisements. In certain implementations, the disclosed system may also receive the preferences of the caller, and based on these preferences and phone numbers, the system can play audio messages targeted to the caller. Also, it is understood that instead of having the phone number of the caller, a unique identification number can also be used, such as for privacy concerns.

The disclosed system, upon detecting the signal tone can start playing the predefined audio messages between the signal tones, at step 330. The system may know the exact timing of playing the signal tones and based on which the system can play the audio messages. The system can keep playing the audio messages in a loop until the receiver of the call picks up the call or the call gets terminated.

The disclosed system can receive audio messages to be played and information about playing the audio messages from the users, such as companies wanting to advertise their products or services. The order can be received through the 800 number and website. The information can include the order, the area codes for which the audio messages have to be played, and the dates on which the audio messages have to be played. The disclosed system through an interface can provide a form for receiving such information from the user in a structured format. This may allow for automated processing of the orders. A suitable payment interface can also be provided for paying the fees of the order.

In general, an ad in the form of an audio message can be posted between two ringing signals heard by the caller. Each ad can be about 4.5 seconds and the total time between two ringing signals heard by the caller is about six seconds. In one minute, about ten ads can be posted. If thirty audio messages are to be posted, each audio message will be heard every three minutes. It is understood that the number of audio messages played can vary without departing from the scope of the present invention.

For example, on Saturdays, the advertiser can send timely spaced messages to the area code stations to be played in the following week from Monday to Friday. Such a schedule can vary and depends upon the requirements of the advertiser. The area code stations, using the disclosed system, can synchronize the audio messages with the ringing signals and repeat them in a loop. This allows making targeting advertisements to the population of each area code.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. A method for transmitting audio messages in a telephonic call, the method comprising:
receiving a plurality of audio messages from an external server;
processing, by an audio processing unit, the plurality of audio messages to a predetermined format and duration, the predefined format comprises an order in which the plurality of audio messages are to be played and when the plurality of audio messages played, wherein the audio processing unit is configured to trim and split the audio messages based on preset instructions;
playing, by a playing unit, one or more audio messages between consecutive signal tones, so that the caller can hear the one or more audio messages, wherein the signal tones are generated by a generator, the signal tones are played to a caller waiting for a call to be answered, wherein the signal tones indicate a status of the ongoing call, wherein the consecutive signal tones are separated by a predefined duration, wherein the plurality of audio messages in the order are played in a loop;
receiving preferences for audio messages from the caller for audio messages; and
associating the preferences with a phone number of the caller, wherein the phone number is masked by a unique identification number, wherein the plurality of audio messages played to the caller are based on the preferences.

2. The method according to claim 1, wherein the predefined duration is 5 seconds.

3. (canceled)

4. The method according to claim 1, wherein the generator and the playing unit are different.

5. The method according to claim 1, wherein the method further comprises:
determining the predefined duration based on signal tones.

6. The method according to claim 3, wherein the method further comprises:
receiving information about playing of the plurality of audio messages from the external server, wherein the information comprises number of times an audio message of the plurality of messages is to be played, area codes for which the audio message is to be played, and days in which the audio message is to be played.

7. A system for transmitting audio messages in a telephonic call, the system comprising a playing unit, the system configured to implement a method comprising:
receiving a plurality of audio messages from an external server;
processing, by an audio processing unit, the plurality of audio messages to a predetermined format and duration, the predefined format comprises an order in which the plurality of audio messages are to be played and when the plurality of audio messages played, wherein the audio processing unit is configured to trim and split the audio messages based on preset instructions
playing, by the playing unit, one or more audio messages between consecutive signal tones so that the caller can hear the one or more audio messages, wherein the signal tones are generated by a generator, the signal tones are played to a caller waiting for a call to be answered, wherein the signal tones indicate a status of the ongoing call, wherein the consecutive signal tones are separated by a predefined duration, wherein the plurality of audio messages in the order are played in a loop;
receiving preferences for audio messages from the caller for audio messages; and
associating the preferences with a phone number of the caller, wherein the phone number is masked by a unique identification number, wherein the plurality of audio messages played to the caller are based on the preferences.

8. The system according to claim 7, wherein the predefined duration is 5 seconds.

9. (canceled)

10. The system according to claim 7, wherein the generator and the playing unit are different.

11. The system according to claim 7, wherein the method further comprises:
determining the predefined duration based on signal tones.

12. The system according to claim 9, wherein the method further comprises:
receiving information about playing of the plurality of audio messages from the external server, wherein the information comprises number of times an audio message of the plurality of messages is to be played, area codes for which the audio message is to be played, and days in which the audio message is to be played.
